(19) United States
(12) Patent Application Publication
(10) Pub. No.: US 2025/0077909 A1
(43) Pub. Date: Mar. 6, 2025

(54) ASSISTED CONTEXT GENERATION FOR ENHANCED ACCURACY IN DOCUMENT INFERENCING

(71) Applicant: Dell Products L.P., Round Rock, TX (US)

(72) Inventors: Michael Barnes, Doylestown, PA (US); Sivakumar Kondaraju, Cary, NC (US); Abinandaraj Rajendran, Morrisville, NC (US); Zachary W Arnold, Royal Oak, MI (US)

(21) Appl. No.: 18/458,540

(22) Filed: Aug. 30, 2023

(51) Int. Cl. G06N 5/04

(52) U.S. Cl. CPC G06N 5/04

(57) ABSTRACT

A method for assisted context generation for enhanced accuracy in document inferencing includes designating, by a device including a processor and in response to an input prompt, a selected context information source from a group of context information sources using a first machine learning model. The selected context information source is designated based on relevance of the selected context information source to the input prompt. The method further includes constructing, by the device and using a second machine learning model that is not the first machine learning model, a human-readable response to the input prompt by applying parameters of the second machine learning model to the input prompt and the selected context information source.

### BACKGROUND

A generative pre-trained transformer (GPT) model is an autoregressive language model that can utilize deep learning to produce human-like text. For instance, given an initial text prompt, it can produce text that continues the prompt, e.g., by predicting tokens corresponding to the output text based on previous tokens.

Some GPT models, such as the GPT-3 model released in 2020, can further be classified as large language models (LLMs) based on the number of parameters associated with the model. As the number of parameters used by a LLM increases, the computational complexity of training and using the model similarly increases.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a context generation component that selects, using a first machine learning model, an information source from a group of information sources based on relevance of the information source to an input prompt, resulting in a selected information source. The executable components can also include a response formulation component that transforms, using a second machine learning model that is not the first machine learning model, the input prompt into a human-readable response, the human-readable response being constructed by applying parameters of the second machine learning model to information in the selected information source.

In another implementation, a method is described herein. The method can include designating, by a device including a processor and in response to an input prompt, a selected context information source from a group of context information sources using a first machine learning mode. The selected context information source can be designated based on relevance of the selected context information source to the input prompt. The method can further include constructing, by the device and using a second machine learning model that is not the first machine learning model, a human-readable response to the input prompt by applying parameters of the second machine learning model to the input prompt and the selected context information source.

In an additional implementation, a non-transitory machine-readable medium is described herein that can include instructions that, when executed by a processor, facilitate performance of operations. The operations can include, in response to obtaining a question input and using a first machine learning model, selecting an information source from a group of information sources based on a context score assigned to the information source by the first machine learning model, resulting in a context information source, where the context score is representative of an amount of context information pertaining to the question input contained in the context information source; and, using a second machine learning model that is not the first machine learning model, forming a human-readable response output to the question input by applying parameters of the second machine learning model to the question input and the context information.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates assisted context generation for enhanced accuracy in document inferencing in accordance with various implementations described herein.

FIG. 2 is a diagram depicting example interactions between machine learning models that can be performed in various implementations described herein.

FIGS. 3-4 are respective block diagrams of another system that facilitates assisted context generation for enhanced accuracy in document inferencing in accordance with various implementations described herein.

FIG. 5 is a diagram depicting additional example interactions between machine learning models that can be performed in various implementations described herein.

FIGS. 6-8 are respective block diagrams of additional systems that facilitate assisted context generation for enhanced accuracy in document inferencing in accordance with various implementations described herein.

FIG. 9 is a flow diagram of a method that facilitates assisted context generation for enhanced accuracy in document inferencing in accordance with various implementations described herein.

FIG. 10 is a flow diagram depicting respective operations facilitating assisted context generation for enhanced accuracy in document inferencing that can performed by a processor in accordance with various implementations described herein.

FIGS. 11-12 are diagrams of example computing environments in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

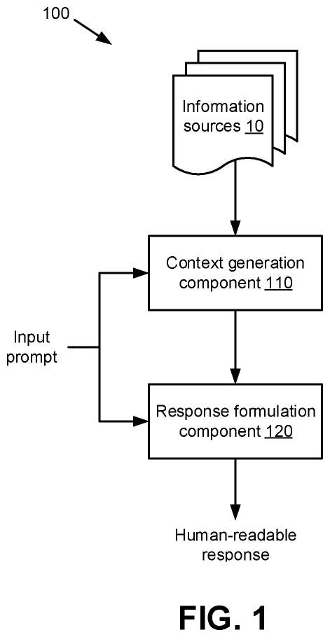

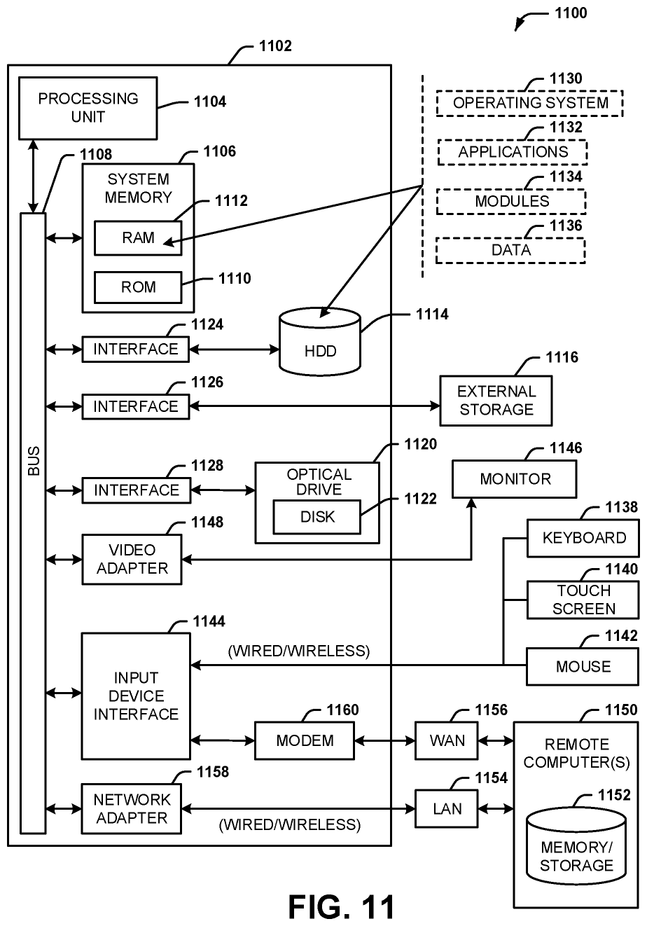

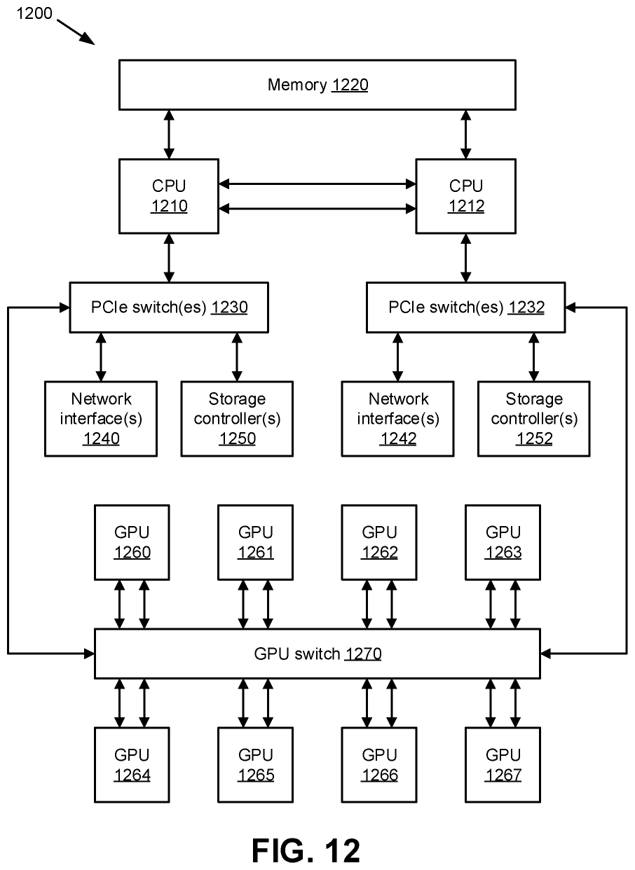

With reference now to the drawings, FIG. 1 illustrates a block diagram of a system 100 that facilitates assisted context generation for enhanced accuracy in document inferencing in accordance with various implementations described herein. System 100 as shown in FIG. 1 includes a context generation component 110 and a response formulation component 120, each of which can operate as described in further detail below. In an implementation, the components 110, 120 of system 100 can be implemented in hardware, software, or a combination of hardware and software. By way of example, the components 110, 120 can be implemented as computer-executable components, e.g., components stored on a memory and executed by a processor. Examples of computer architectures including a processor and a memory that can be used to implement the components 110, 120, as well as other components as will be described herein, are shown and described in further detail below with respect to FIGS. 11-12.

Additionally, it is noted that the functionality of the respective components shown and described herein can be implemented via a single computing device and/or a combination of devices. For instance, in various implementations, the context generation component 110 shown in FIG. 1 could be implemented via a first device, and the response formulation component 120 could be implemented via the first device or a second device. Also, or alternatively, the functionality of a single component could be divided among multiple devices in some implementations.

The context generation component 110 and the response formulation component 120 shown in FIG. 1 can be utilized to generate human-readable responses to an input prompt such as a question. As used herein, a “human-readable response” is defined as a response that includes one or more intelligible statements that are formed in a human-readable language. While various implementations described herein refer to example cases in which a response is formed in English using standard text, it is noted that system 100 could process text or other information in other suitable human-readable languages, or alternative alphabets or text formats associated with those languages such as Braille or the like, without departing from the scope of this disclosure or the claimed subject matter.

As noted above, a generative pre-trained transformer (GPT) model can use deep learning to produce human-readable text output. However, large language models (LLMs) such as GPT models often require significant computing resources to train and utilize, and this impairs the ability of such a model to be deployed in a scalable manner and provide responses in a reasonable period of time without significant resources. By way of example, the GPT-3 model is a decoder-only transformer network with 175 billion parameters, requiring approximately 800 gigabytes to store. Future GPT models, such as the upcoming GPT-4 model, will require even more resources. As the number of parameters associated with an LLM increases, the computational expense associated with training the model and performing inferences similarly increases.

In addition to the amount of resources associated with a GPT model or other LLM, GPT models tend to give generic answers that are not specific to a given topic unless a specific context is supplied to the model. While topic-specific responses can be generated by a GPT model based on context contained in stored documents or other sources, there is a limit to the amount of context that can be practically supplied to a GPT model. This, in turn, imposes limits on the specificity of responses that can be generated by the model for a given topic.

In view of at least the above, described herein are techniques that can leverage interactions between multiple machine learning models to improve the relevance and accuracy of responses produced by a language model as well as to enable smaller language models (e.g., in terms of number of parameters, etc.) to provide results that are of similar quality to larger language models. For instance, a deep learning question answering (QA) model or a similar model can be used to provide context to a language model such as a GPT model, e.g., by attempting to answer the same question from each of a collection of documents or other sources in a data store and providing a score that can be used as a ranking. These rankings, and/or respective sources selected by the QA model based on the rankings, can then be utilized by the language model to provide answers relating to a particular topic with higher specificity. While the above example utilizes a QA model and a GPT model, it is noted that other types of models could be utilized to attain similar results, as will be described in further detail below.

It is also noted that, due to the nature and quantity of data that can be processed as described herein, as well as the manner in which such data is processed, implementations described herein can facilitate operations that could not be performed by a human, or by a general-purpose computer utilizing conventional computing techniques, in a useful or reasonable timeframe. Additionally, implementations described herein can enable document inferencing to be performed using a comparatively small language model, which can improve the performance of a computing system in terms of reduced resource consumption (e.g., consumption of power, processor cycles, memory cycles, network bandwidth, etc.) or other metrics. Use of a comparatively small, large language model (LLM) as described herein can also enable accurate and specific document inferencing to be performed by computing devices that could not utilize larger language models due to resource limitations. Other advantages of the implementations described herein are also possible. These smaller LLM's tend to accept smaller context, e.g., in the range of 2048 to 32000 tokens.

With reference now to the components of system 100, the context generation component 110 can select, using a first machine learning model, one or more information sources from a group of information sources 10 based on the relevance of the selected information source(s) to an input prompt. In various implementations, the machine learning model utilized by the context generation component 110 can be a QA model, a term frequency-inverse document frequency (TF-IDF) model, and/or any other type of ML model that is suitable for ranking sources of information based on their relevance to a prompt. The selected information source(s) can then be provided by the context generation component 110 as additional input to the response formulation component 120.

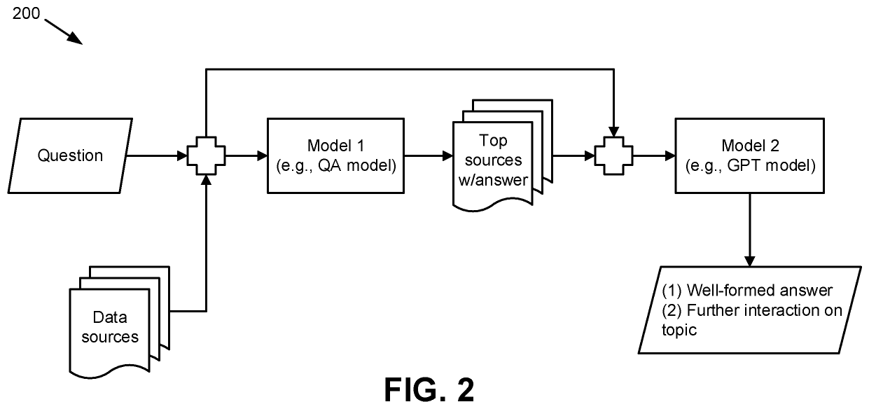

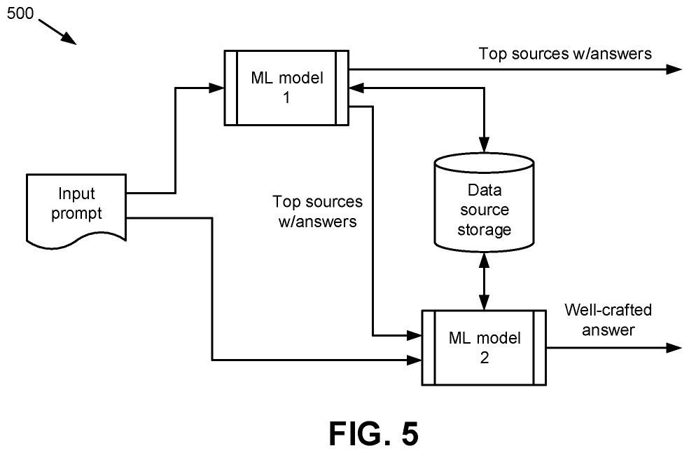

The response formulation component 120, in turn, can transform, using a second ML model that is not the first ML model used by the context generation component 110, the input prompt into a human-readable response based on information contained in the selected information source(s) designated by the context generation component 110. In an implementation, the second ML model can be a GPT model or other language model, and the response formulation component 120 can generate the human-readable response to the input prompt by applying parameters of the language model to the input prompt and context information located in the selected context source(s). Various implementations of the context generation component 110 and the response formulation component 120, including models that can be utilized by said components 110, 120, are described in further detail below with respect to FIG. 2 and FIG. 5.

The information sources 10 shown in FIG. 1 and utilized by the components 110, 120 of system 100 can be of any type that is suitable for providing context information relating to an input prompt. By way of example, the information sources can include text documents, images (with or without text), videos, audio recordings or other audio files, or the like. In the event that some of the information sources 10 are of types other than text documents, the context generation component 110 can leverage other ML models in addition to text-based models, such as image classification models, audio recognition models, etc., to extract and/or rank context information present in those sources.

In various implementations, the manner in which the context generation component 110 provides context information to the response formulation component 120 can vary. By way of example, the context generation component 110 can provide copies of relevant information sources 10 to the response formulation component 120 in response to an input question or prompt. The context generation component 110 could also provide a reference to selected information sources in addition to, or in place of, copies of the sources. A reference to an information source as provided by the context generation component 110 could include an identification of the selected source (e.g., a source title, a reference number associated with the source in a knowledge base or other indexed information system, etc.), a link or other reference to a location of the selected source within a data storage system, and/or any other suitable information.

In a non-limiting implementation in which the information sources 10 correspond to articles of a knowledge base for a computing system and/or components thereof, the context generation component 110 can utilize a lightweight model as described above to examine the knowledge base and obtain a set of articles from the knowledge base that relate to particular topics covered by the knowledge base. For instance, if the input prompt includes a question relating to a particular computing device, the context generation component 110 can select articles from the knowledge base that relate to that computing device and provide those articles as context to the response formulation component 120. By doing so, the response formulation component 120 can provide an answer to the input prompt that specifically relates to the device at issue without context information for that device being manually entered and/or otherwise separately provided to the response formulation component 120.

It is noted that the above example of a knowledge base is merely one example of a group of information sources 10 that can be managed by system 100 and that other examples are also possible. For instance, the information sources 10 can include marketing and/or sales documentation relating to various products or services, and system 100 could be used to provide tailored recommendations in response to an input prompt seeking assistance in selecting from among the represented products or services. More generally, system 100 could be utilized in connection with any use case in which context information is desirably provisioned to an LLM or a similar model in order to provide responses to input questions or prompts with improved accuracy and/or particularity, and all such implementations are intended to be covered by this description and the claimed subject matter unless explicitly stated otherwise.

With reference next to FIG. 2, a diagram 200 depicting example interactions between machine learning models that can be performed in various implementations described herein is illustrated. As shown by diagram 200, a first ML model can be used to provide context to a second ML model, e.g., by attempting to answer the same question from each of a set of data sources in an associated data store and ranking the sources based on these attempts. In one implementation represented by diagram 200, the first ML model can be a QA model, e.g., a Bidirectional Encoder Representations from Transformers (BERT)-based transformer or bidirectional long-short term memory (bi-LSTM) with attention layers, and the second ML model can be a GPT model. It is noted, however, that other ML models could also be used.

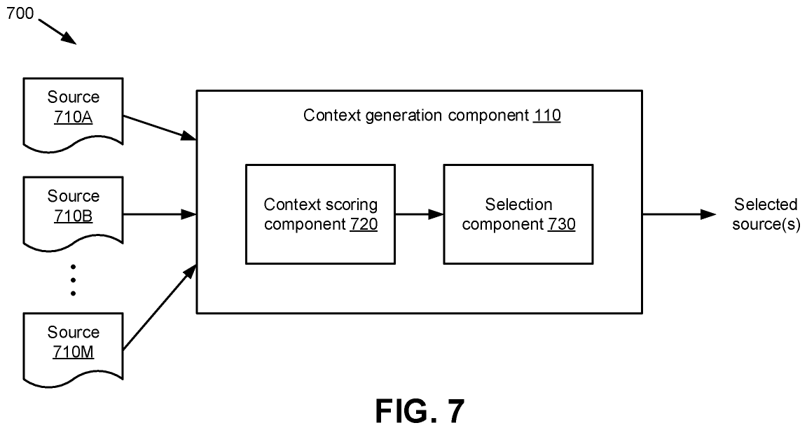

Diagram 200 represents an implementation in which two deep learning models are used together, where the first model supplies context to the second model by, e.g., scoring, ranking, and/or other processes. For instance, the first model can scan some or all of the data sources (e.g., knowledge base articles or other documents, etc.) and provide scoring with one-sentence answers and/or other suitable techniques for assigning relative relevancy values to the respective sources. This scoring can then be used to rank the sources in terms of the sources that provide the best answer to the provided question. Techniques that can be employed by the first ML model for scoring and/or ranking data sources are described in further detail below with respect to FIG. 7.

A designated number of the top sources identified by the first ML model (e.g., the top five sources, the top ten sources, etc.) as described above can be provided as context to the second ML model, e.g., an LLM GPT model, that can provide quality text answers to questions from the provided context. In an implementation in which the second ML model is an LLM GPT model, the implementation shown by diagram 200 can enable the effective use of lower rank parameter LLMs for GPT where inferences can be run on as few resources as a single graphics processing unit (GPU), e.g., as opposed to larger models that would require more powerful computing devices and/or cloud implementations due to their size, while still providing quality answers to presented questions.

In the example implementation shown by diagram 200, the strengths of different ML model types can be leveraged to provide higher quality answers to questions or other input prompts than would be achievable by a single model alone. For instance, a QA model and/or other suitable model can be utilized to quickly traverse a set of data sources to find respective sources that best answer a given question, and these sources can then be passed as context to a GPT model and/or other suitable model that can articulate a well-formed answer to the question from that context. As the resulting combination of ML models can be run using a single GPU as noted above, an implementation as shown by diagram 200 can provide flexible implementation via computing systems of any specifications while also providing scalability for implementations having large amounts of potential context information. In contrast, an implementation in which a language model is utilized without a supporting model for context provision would require specific training on the set of data sources, which would increase the amount of computing resources needed to train and use the model significantly while still yielding responses that are of lesser quality than those provided by a context-aided system.

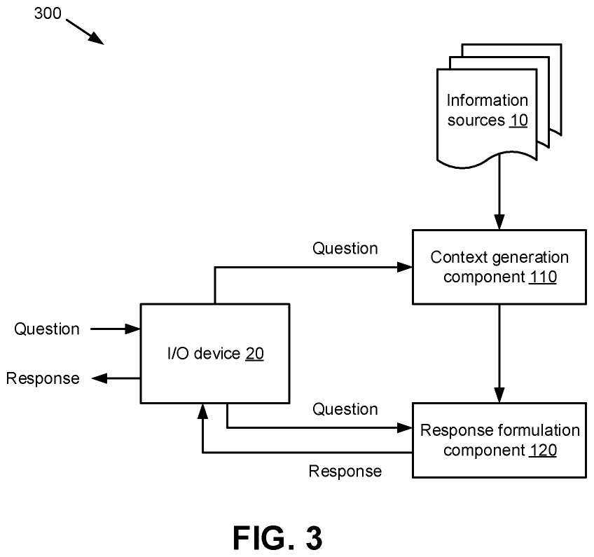

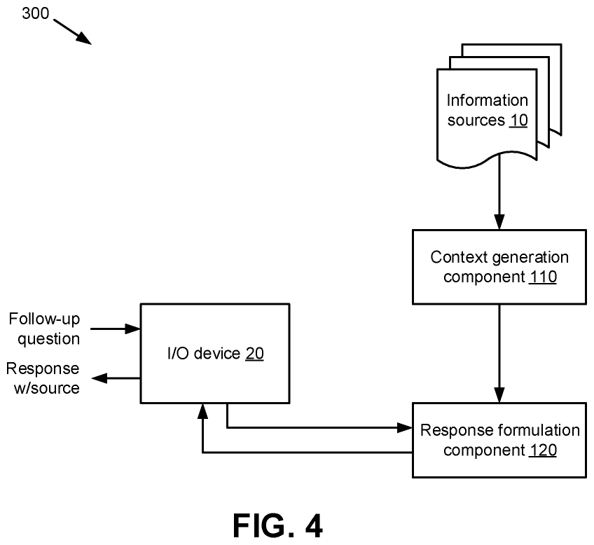

As further shown in diagram 200, the output of the second ML model can enable further interaction on a topic relating to the original submitted question. An example of this capability is shown in FIGS. 3-4, which illustrate block diagrams of another system 300 that can facilitate assisted context generation for enhanced accuracy in document inferencing. Repetitive description of like parts described above with regard to other implementations is omitted for brevity. With reference first to FIG. 3, system 300 includes an input/output (I/O) device 20 with which a user or other entity can enter an input question. In an implementation, the I/O device 20 can be a peripheral device that can receive input data and/or render output data, such as a keyboard, mouse, touchscreen, monitor, speaker, or the like. Alternatively, the I/O device 20 can be a computing device that includes one or more peripheral devices as described above.

While FIGS. 3-4 and various other implementations described herein refer to a “question” being provided as input, it is noted that the term “question” as used herein is intended to refer to both direct questions and indirect queries. For example, the term “question” as used herein can refer to a direct question, a combination of keywords (e.g., provided in lieu of an actual question), a rephrased question, a vague and/or nonspecific question, and/or any other suitable input prompt of any format. Thus, by way of example, the inputs “What could cause cluster creation to fail?” and “cluster creation failure causes” could both be processed by system 300 as a question. Other formats could also be used.

As further shown by FIG. 3, a question received as input by the I/O device 20 can be provided to both a context generation component 110 and a response formulation component 120, each of which can operate as described above with respect to FIG. 1. For instance, the context generation component 110 can identify context information relevant to the question from a set of information sources 10 and provide this context information to the response formulation component 120 to articulate a response to the question. The response generated by the response formulation component 120 in this manner can then be provided to the I/O device 20, e.g., for use by an entity that provided the question.

In some implementations, the response to the question as provided to the I/O device 20 can include the most relevant sources identified by the context generation component 110 as well as the answer generated by the response formulation component 120 to the provided question. Alternatively, the formulated answer to the input question can initially be provided to the I/O device without the relevant sources, and the sources can subsequently be made available via the I/O device 20 upon request, e.g., in a follow-up question.

An example of the above is shown by FIG. 4, where system 300 can provide the capability to ask further questions related to the provided context from the initial question. In the event that a follow-up question relates to the same context as a previous question, the response formulation component 120 can, in some implementations, generate an answer to the follow-up question using the same context information as was used in the previous question, e.g., without further intervention from the context generation component 110. In the event that the follow-up question includes a request for the information source(s) used to answer the original question, the response formulation component 120 can include a link to a location of the source(s) within a data storage system associated with the I/O device 20 and/or otherwise identify the source(s) used to facilitate a further review of those sources by an entity that input the question.

To state the operations shown in FIGS. 3-4 another way, a first question or input prompt can be provided to the context generation component 110 and the response formulation component 120 via an I/O device 20. The response formulation component 120 can then generate a first response to this first question based on context supplied by the context generation component 110 and provide this first response to the I/O device 20. Subsequently, in response to a second question or input prompt that relates to the first question or prompt, the response formulation component 120 can generate a second response using the context information associated with the first prompt. In some cases, this second response can include copies of the utilized context information sources or locations, identifiers, and/or other properties of those sources.

With reference now to FIG. 5, a diagram 500 depicting another example of interactions between machine learning models that can be performed in various implementations described herein is illustrated. As shown in FIG. 5, an input prompt (e.g., a question) can be provided to a pair of ML models. The first ML model can respond to the input prompt by accessing respective data sources, e.g., within a data store. From these data sources, the first ML model can identify one or more sources that best answer the input prompt and/or otherwise the most relevant to the input prompt. These identified sources can be provided from the first ML model to the second ML model, which can utilize the identified sources to form a well-crafted human-readable response to the input prompt.

As shown in diagram 500, a response to the input prompt can, in some implementations, include both the top sources identified by the first ML model and the answer crafted by the second ML model. These items can be provided together within the same response and/or as part of separate responses. In one example, the identified sources can be provided in a later response to the input prompt, e.g., in response to a request received subsequent to the input prompt, to aid a user or other requesting entity in fact checking the provided answer if desired.

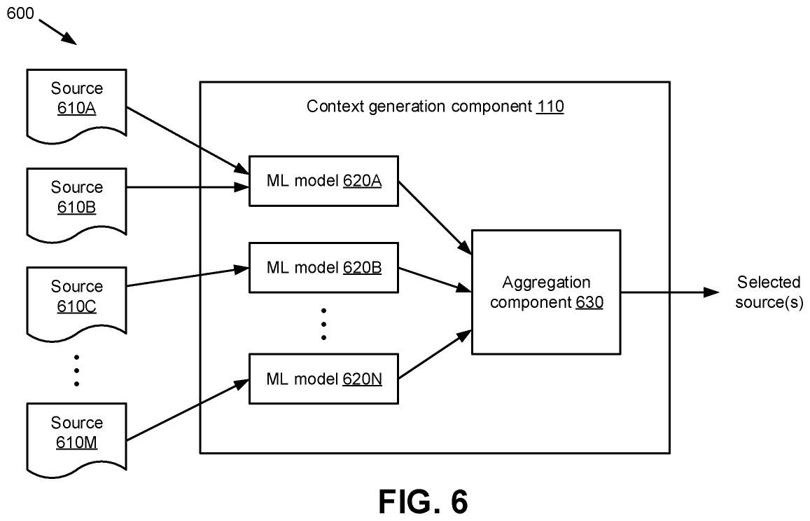

Turning to FIG. 6, a block diagram of another system 600 that facilitates assisted context generation for enhanced accuracy in document inferencing is illustrated. Repetitive description of like parts described above with regard to other implementations is omitted for brevity. System 600 as shown in FIG. 6 includes a context generation component 110 that can select context information from respective sources, here M sources 610A-610M, as described above.

In the implementation shown by FIG. 6, the context generation component 110 is associated with a group of ML models, here N ML models 620A-620N, which can identify context information among different subgroups of the sources 610A-610M. It is noted that the naming conventions utilized for the sources 610A-610M and the ML models 620A-620N are for illustrative purposes only and are not intended to imply any specific numbers of sources and/or ML models. It is further noted that an implementation such as that shown by FIG. 6 could include any number of sources, including one source or multiple sources, and any number of ML models, including one ML model or multiple ML models.

In some implementations, the ML models 620 utilized by the context generation component 110 can be of different model types, e.g., for processing different types of sources 610. For instance, FIG. 6 illustrates an implementation where sources 610A and 610B are of a first type (e.g., document, audio, image, video, etc.) and are processed by a first ML model 620A, source 610C is of a second, different type and is processed by a second ML model 620B, and source 610M is of a third type and is processed by a third ML model 620N. While not shown in FIG. 6, a single source 610 could also be processed via multiple ML models 620 in some implementations. In still other implementations, respective ones of the ML models could be of the same model type but trained differently, e.g., for different types of queries, subject matter, or the like. Other implementations are also possible.

As further shown in FIG. 6, the context generation component 110 can further utilize an aggregation component 630 to synthesize the outputs of the respective ML models 620, e.g., in order to produce a common output. In some implementations, the aggregation component 630 can itself be a ML model that is trained to combine, prune, or otherwise organize the sources identified by the initial ML models 620 according to some criteria. For instance, the aggregation component 630 could receive outputs from respective ones of the ML models 620 and forward only a selected portion of those outputs as the output of the context generation component 110. Also or alternatively, the aggregation component 630 can include formatting logic and/or other means for standardizing the output of the different ML models 620 before providing those outputs to other components. In still other implementations, the context generation component 110 may not include an aggregation component 630, and the ML models 620 can directly provide their outputs to other components. Other implementations are also possible.

Referring next to FIG. 7, a block diagram of still another system 700 that facilitates assisted context generation for enhanced accuracy in document inferencing is illustrated. Repetitive description of like parts described above with regard to other implementations is omitted for brevity. System 700 as shown in FIG. 7 includes a context generation component 110 that can select from among a group of context information sources, here M sources 710A-710M. The context generation component 110 includes a context scoring component 720 that can assign scores, e.g., relevance scores, context scores, etc., to respective ones of the sources 710 based on their relevance to an input prompt. The context generation component 110 further includes a selection component 730, which can select respective ones of the sources 710 based on the scores assigned to them by the context scoring component 720.

In some implementations, the context scoring component 720 and/or the selection component 730 can be implemented via one or more ML models, such as a QA model or the like, as described above. In an implementation in which the context generation component 110 is associated with multiple ML models, such as the implementation shown in FIG. 6, each of the respective models can independently implement the context scoring component 720 and/or the selection component 730, e.g., to assign context scores to respective subsets of the sources 710 that are managed by each of the associated models. In various implementations, scores assigned to respective sources by the context scoring component 720 can be numerical values and/or any other suitable indicator of the relative relevance of respective ones of the sources 710.

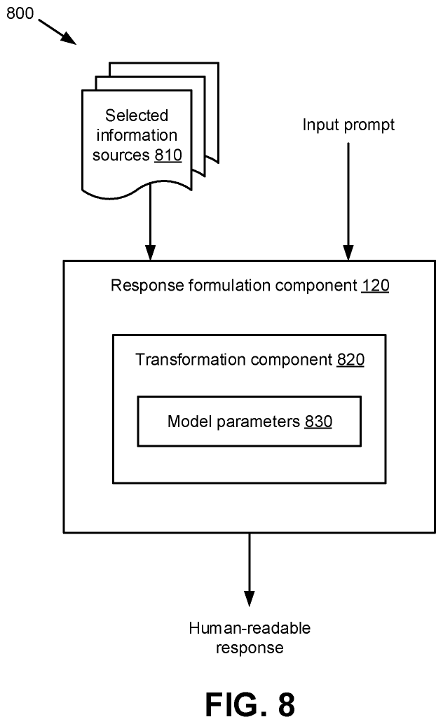

Referring now to FIG. 8, a block diagram of a further system 800 that facilitates assisted context generation for enhanced accuracy in document inferencing is illustrated. Repetitive description of like parts described above with regard to other implementations is omitted for brevity. System 800 as shown in FIG. 8 includes a response formulation component 120, which can generate a human-readable response from an input prompt based on one or more selected information sources 810 (e.g., as selected by a context generation component 110 as context information as described above). To this end, the response formulation component 120 includes a transformation component 820, which can be implemented via a GPT model and/or another suitable type of ML model. The transformation component 820, in turn, is associated with a set of model parameters 830 that can guide the operation of the transformation component 820 in transforming the input prompt into an intelligible answer. As the number of model parameters 830 can be significantly large, e.g., on the order of billions to potentially trillions of parameters, the transformation component 820 can leverage the complete set of model parameters 830 in a manner that could not be performed in the human mind in a useful or reasonable timeframe.

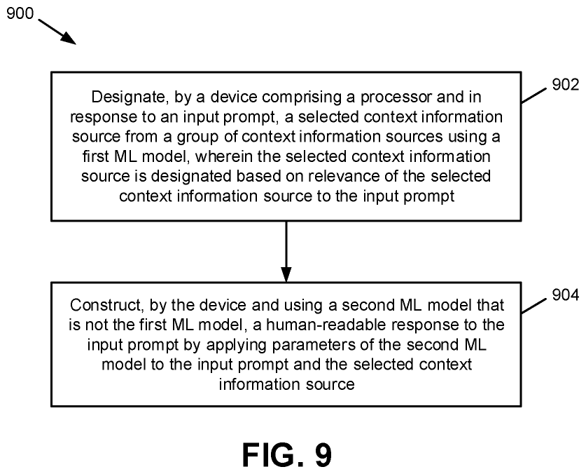

Turning to FIG. 9, a flow diagram of a method 900 that facilitates assisted context generation for enhanced accuracy in document inferencing is illustrated. At 902, in response to an input prompt, a device comprising a processor can designate (e.g., by a context generation component 110) a selected context information source from a group of context information sources (e.g., information sources 10) using a first ML model. The selected context information sources can be designated at 902 based on relevance of the selected context information source to the input prompt.

At 904, the device can construct (e.g., by a response formulation component 120), using a second ML model that is not the first ML model, a human-readable response to the input prompt by applying parameters of the second ML model to the input prompt and the selected context information source designated at 902.

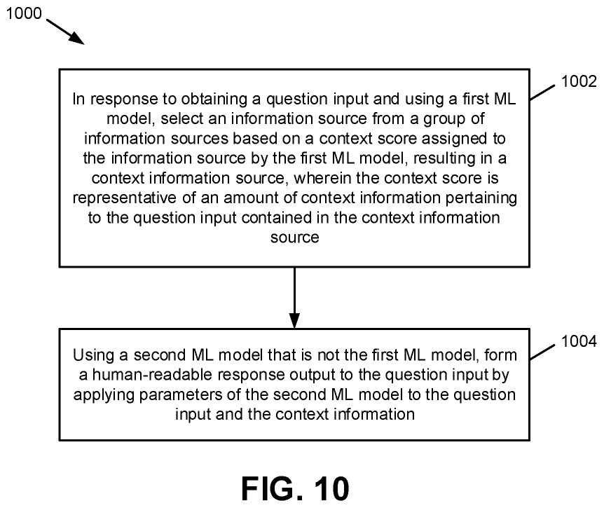

Referring next to FIG. 10, a flow diagram of a method 1000 that can be performed by a processor, e.g., based on machine-executable instructions stored on a non-transitory machine-readable medium, is illustrated. An example of a computer architecture, including a processor and non-transitory media, that can be utilized to implement method 1000 is described below with respect to FIG. 11.

Method 1000 can begin at 1002, in which the processor, in response to a question input and using a first ML model, can select an information source from a group of information sources based on a context score assigned to the information source by the first ML model, resulting in a context information source. The context score can be representative of an amount of context information pertaining to the question input that is contained in the context information source.

At 1004, the processor can, using a second ML model that is not the first ML model, form a human-readable response output to the question input by applying parameters of the second ML model to the question input and the context information identified at 1002.

FIGS. 9-10 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIGS. 11-12 and the following discussion are intended to provide a brief, general description of suitable computing environments 1100, 1200 in which the various embodiments of the embodiment described herein can be implemented. More particularly, FIG. 11 illustrates a general-purpose computing environment 1100 that can be utilized to implement the I/O device 20 shown in FIGS. 3-4 and/or respective other computer-executable components described above, while FIG. 12 illustrates a server computing environment 1200 on which one or more ML models as described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 11, an example general-purpose environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD), a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning next to FIG. 12, an example server architecture 1200 that can be utilized in connection with one or more implementations described above is illustrated. The server architecture 1200 shown in FIG. 12 can be associated with a server device, such as a rackmount server, a blade server, or the like, which can be physically and/or communicatively coupled to a chassis (not shown in FIG. 12) and/or other physical devices for use in a computing environment such as a computing cloud, a data center, etc.

The server architecture 1200 shown in FIG. 12, referred to below as simply a server for brevity, can include one or more central processing units (CPUs), here two CPUs 1210, 1212. In a typical implementation of the server 1200, the CPUs 1210, 1212 are high-performance server processors that provide scalability and a high number of processing cores per CPU, e.g., up to 56 cores per processor for current implementations. The CPUs 1210, 1212 of the server 1200 are communicatively coupled to each other by, e.g., processor interconnect links, such as QuickPath Interconnect (QPI) or Ultra Path Interconnect (UPI) links developed by the Intel® Corporation. Alternatively, other means for coupling the CPUs 1210, 1212, such as a front side bus (FSB) or the like, could also be used. While two interconnect links are shown in FIG. 12 coupling CPUs 1210 and 1212, it is noted that more, or fewer, links could also be used.

The CPUs 1210, 1212 shown in FIG. 12 are additionally coupled to a system memory 1220, which can include one or more Dual In-line Memory Modules (DIMMs) and/or other devices. While the system memory 1220 is illustrated as a single block in FIG. 12 for simplicity, it is noted that the system memory 1220 is typically implemented via a group of memory modules. For example, the CPUs 1210, 1212 can collectively be associated with a number of DIMM slots (e.g., 16 slots, 32 slots, etc.), and DIMMs making up the system memory 1220 can be placed into these slots to facilitate connection to the CPUs 1210, 1212. Depending on implementation, the memory modules making up the system memory 1220 can be communicatively coupled to one, or more, of the CPUs 1210, 1212.

As further shown in FIG. 12, Peripheral Component Interconnect Express (PCIe) switches 1230, 1232 can connect the CPUs 1210, 1212 to respective other components of the server 1200, such as network interfaces 1240, 1242, storage controllers 1250, 1252, or the like. The network interfaces 1240, 1242 can include network interface cards (NICs) and/or other suitable components to facilitate connecting the server 1200 to other servers or suitable computing devices, e.g., in a clustered computing environment. The storage controllers 1250, 1252 can include nonvolatile memory express (NVMe) controllers and/or other interface devices that facilitate the coupling of storage devices, such as non-volatile RAM (NVRAM) devices, SSDs, or the like, to the server 1200.

While FIG. 12 shows a configuration in which each CPU 1210, 1212 is connected to one PCIe switch 1230, 1232, other configurations could be used. For instance, a one-to-many or many-to-one connection scheme could be used between the CPUs 1210, 1212 and the PCIe switches 1230, 1232. Similarly, the network interfaces 1240, 1242 and storage controllers 1250, 1252 could be connected to the PCIe switches 1230, 1232 in a one-to-many or many-to-one configuration in addition to, or in place of, the one-to-one connection scheme shown in FIG. 12.

The server 1200 shown in FIG. 12 further includes a group of co-processors, such as graphics processing units (GPUs), intelligence processing units (IPUs) for artificial intelligence workloads, etc.; in FIG. 12, there are eight GPUs 1260-1267, which provide further processing capability to server 1200. While eight GPUs 1260-1267 are shown in FIG. 12, more, or fewer, GPUs could also be used. The GPUs 1260-1267 of server 1200 are preferably specialized GPUs that are designed for high-performance computing applications, such as H100 and/or A100 GPUs developed by the NVIDIA® Corporation, although other GPUs, IPUs, etc., could also be used. Each of the GPUs 1260-1267 of the server are communicatively coupled to each other via suitable communications links, such as NVLink® interconnects developed by the NVIDIA® Corporation and/or other suitable connections. In the example shown by FIG. 12, a GPU 1270 facilitates full interconnection between the GPUs 1260-1267. In other implementations, the GPUs 1260-1267 could instead be interconnected directly without the use of a switch or other means.

As additionally shown by FIG. 12, the GPU 1270 is communicatively coupled to the PCIe switches 1230, 1232 to enable communication between the GPUs 1260-1267 and other components of the server 1200. Other connection schemes could also be used. For instance, one or more of the GPUs 1260-1267 could connect to the PCIe switches 1230, 1232 and/or the CPUs 1210, 1212 directly, e.g., in an implementation in which a GPU 1270 is not present. In this architecture, the deep learning models would be executed in the GPUs 1260-1267 rather than the CPUs 1210, 1212.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a context generation component that selects, using a first machine learning model, an information source from a group of information sources based on relevance of the information source to an input prompt, resulting in a selected information source; and
a response formulation component that transforms, using a second machine learning model that is not the first machine learning model, the input prompt into a human-readable response, the human-readable response being constructed by applying parameters of the second machine learning model to information in the selected information source.

2. The system of claim 1, wherein the first machine learning model is a question answering model.

3. The system of claim 1, wherein the second machine learning model is a generative pre-trained transformer model.

4. The system of claim 1, wherein the human-readable response is a first human-readable response, and wherein the response formulation component further generates a second human-readable response including an identification of the selected information sources.

5. The system of claim 4, wherein the input prompt is a first input prompt, and wherein the response formulation component generates the second human-readable response in response to a second input prompt received by the response formulation component subsequent to the first input prompt and based on the selected information source received from the context generation component in response to the first input prompt.

6. The system of claim 1, wherein:
the context generation component selects, using a group of first machine learning models comprising the first machine learning model, information sources comprising the selected information source from subgroups of the group of information sources, resulting in a group of selected information sources comprising the selected information source, and
the subgroups of the group of information sources are associated with respective ones of the group of first machine learning models.

7. The system of claim 6, wherein a first one of the group of first machine learning models is of a first model type, and wherein a second one of the group of first machine learning models is of a second model type that is not the first model type.

8. The system of claim 6, wherein the selected information source is a first selected information source, wherein the information in the selected information source is first information, and wherein the response formulation component constructs the human-readable response using the first information and second information in a second selected information source of the group of selected information sources.

9. The system of claim 1, wherein respective ones of the group of information sources are of a source type selected from a group of source types comprising a text document, an image, a video, and an audio recording.

10. A method, comprising:
designating, by a device comprising a processor and in response to an input prompt, a selected context information source from a group of context information sources using a first machine learning model, wherein the selected context information source is designated based on relevance of the selected context information source to the input prompt; and
constructing, by the device and using a second machine learning model that is not the first machine learning model, a human-readable response to the input prompt by applying parameters of the second machine learning model to the input prompt and the selected context information source.

11. The method of claim 10, wherein the first machine learning model is a question answering model.

12. The method of claim 10, wherein the second machine learning model is a generative pre-trained transformer model.

13. The method of claim 10, wherein the human-readable response comprises an identification of the selected context information source.

14. The method of claim 10, wherein the designating comprises designating, using a group of first machine learning models comprising the first machine learning model, selected context information sources comprising the selected context information source from subgroups of the group of context information sources, and wherein the subgroups of the group of context information sources are associated with respective ones of the group of first machine learning models.

15. The method of claim 14, wherein a first one of the group of first machine learning models is of a first model type, and wherein a second one of the group of first machine learning models is of a second model type that is not the first model type.

16. A non-transitory machine-readable medium comprising computer executable instructions that, when executed by a processor, facilitate performance of operations, the operations comprising:
in response to obtaining a question input and using a first machine learning model, selecting an information source from a group of information sources based on a context score assigned to the information source by the first machine learning model, resulting in a context information source, wherein the context score is representative of an amount of context information pertaining to the question input contained in the context information source; and
using a second machine learning model that is not the first machine learning model, forming a human-readable response output to the question input by applying parameters of the second machine learning model to the question input and the context information.

17. The non-transitory machine-readable medium of claim 16, wherein the first machine learning model is a question answering model.

18. The non-transitory machine-readable medium of claim 16, wherein the second machine learning model is a generative pre-trained transformer model.

19. The non-transitory machine-readable medium of claim 16, wherein the question input is a first question input, wherein the human-readable response output is first human-readable response output, and wherein the operations further comprise:
in response to a second question input that follows the first question input and using the second machine learning model, forming a second human-readable response output, the second human-readable response output comprising a location of the context information source within a data storage system.

20. The non-transitory machine-readable medium of claim 16, wherein the context information source is a first context information source, wherein the group of information sources is a first group of information sources, wherein the context score is a first context score, wherein the amount of context information is a first amount, and wherein the operations further comprise:
in further response to the question input and using a third machine learning model that is not the first machine learning model or the second machine learning model, selecting a second context information source from a second group of information sources based on a second context score assigned to the second context information source by the third machine learning model, wherein the second context score is representative of a second amount of the context information pertaining to the question input contained in the second context information source.
